(19) United States
(12) Patent Application Publication
(10) Pub. No.: US 2024/0143787 A1
(43) Pub. Date: May 2, 2024

(54) MATCHING SOFTWARE SYSTEMS WITH USERS FOR IDENTIFYING SYSTEM DEFECTS

(71) Applicant: Bugcrowd Inc., San Francisco, CA (US)

(72) Inventor: Ian Matthew Conway, San Francisco, CA (US)

(21) Appl. No.: 18/492,717

(22) Filed: Oct. 23, 2023

Related U.S. Application Data
(60) Provisional application No. 63/420,387, filed on Oct. 28, 2022.

(51) Int. Cl. G06F 21/57; G06F 16/951

(52) U.S. Cl. CPC G06F 21/577; G06F 16/951

(57) ABSTRACT

A system assigns target systems to users for identifying system defects. The system ranks the users using a machine learning model. The system extracts a feature vector describing a target system. The system extracts features describing each user. The system provides the features describing the user and the features describing the target system as input to a machine learning model. The machine learning model is trained to receive information describing an input user and an input target system and predict a score indicating a likelihood of the input user providing a system defect in the input target system. The system executes the machine learning model to predict a score for each user. The system ranks the users based on the scores. The system ranks the users based on the scores and communicates with a subset of users selected based on the ranking.

### CROSS REFERENCE TO RELATED APPLICATIONS

This application claims the benefit of priority under 35 USC 119(e) to U.S. Provisional Application No. 63/420,387 entitled “Matching Software Systems with Users for Identifying System Defects,” filed on Oct. 28, 2022, which is incorporated herein by reference in its entirety for all purposes.

### BACKGROUND

### Field of Art

This disclosure relates in general to managing software system defects such as security defects and more specifically to matching target systems for identifying system defects to users.

### Description of the Related Art

Software systems often have defects when the system is released, for example, in production. Certain types of defects are difficult to detect, for example, security defects. Malicious users may have creative ways of finding security holes in systems so that the system can be compromised, and malicious users can get unauthorized access to the sensitive information. Such defects are difficult for quality assurance teams to identify in a software system at testing stage. Crowd sourcing may be used to allow external users to identify and report defects in systems and applications. If external users are allowed to identify and report system defects a very large number of users may work on identifying defects in systems. Interacting with a large number of users working on a target software system may result in waste of system resources.

### SUMMARY

A system assigns targets to users for identifying system defects. A target may be any entity that needs to be analyzed for identifying defects. For example, the target may be a software system, a hardware device, a website, and so on. The system may be used for identifying defects is target systems using crowd sourcing.

The system receives information describing a target system selected for performing analysis for identifying defects. The system receives information describing a plurality of users that are potential candidates for analyzing the target system. The system extracts feature vector describing the target system. The system performing the following steps for each user. The system extracts features describing the user. The system provides the features describing the user and the features describing the target system as input to a machine learning model. The machine learning model is trained to receive information describing an input user and an input target system and predict a score indicating a likelihood of the input user providing a system defect in the input target system. Examples of a machine learning model that may be used for ranking users include a gradient boosted decision tree, although other machine learning models such as neural networks may be used. The system executes the machine learning model to predict a score for each user. The system ranks the plurality of users based on the scores predicted for the users. The system ranks the users based on the scores and communicates with a subset of users selected based on the ranking.

The features describing the target system may include information describing an organization associated with the target system, a type of industry associated with the target system, and one or more types of technologies used by the target system.

The features describing the user may include counts of various categories of prior system defects submitted by the user, counts of each priority of past submissions of the user, total number of past submissions of the user, number of accepted submissions of the user, average priority of the submissions of the user. The features describing the user may include user profile attributes describing interests of the user, qualifications of the user, past experience of the user, and skills of the user.

The features describing the user may be extracted by crawling one or more websites describing user profiles.

The techniques disclosed herein may be implemented as computer-implemented methods or processes; non-transitory computer readable storage medium storing instructions that when executed by one or more computer processors cause the one or more computer processors to perform steps of the methods disclosed herein; or computer systems comprising one or more computer processors and a non-transitory computer readable storage medium storing instructions that when executed by the one or more computer processors cause the one or more computer processors to perform steps of the methods disclosed herein.

### BRIEF DESCRIPTION OF DRAWINGS

FIG. 1 is a block diagram of a system environment for identifying users for analyzing defects in a given target system, according to an embodiment.

FIG. 2 is a block diagram illustrating components of an online system for ranking users for analyzing a target system, according to one embodiment.

FIG. 3 shows illustrates the machine learning model used for evaluating and ranking users, according to an embodiment.

FIG. 4 is a flow chart illustrating the process of ranking users for analyzing defects of a given target system according to an embodiment.

FIG. 5 is a block diagram illustrating a functional view of a typical computer system for use by various embodiments.

The figures depict various embodiments for purposes of illustration only. One skilled in the art will readily recognize from the following discussion that alternative embodiments of the structures and methods illustrated herein may be employed without departing from the principles of the embodiments described herein.

The figures use like reference numerals to identify like elements. A letter after a reference numeral, such as “115a,” indicates that the text refers specifically to the element having that particular reference numeral. A reference numeral in the text without a following letter, such as “115,” refers to any or all of the elements in the figures bearing that reference numeral.

### DETAILED DESCRIPTION

### System Environment

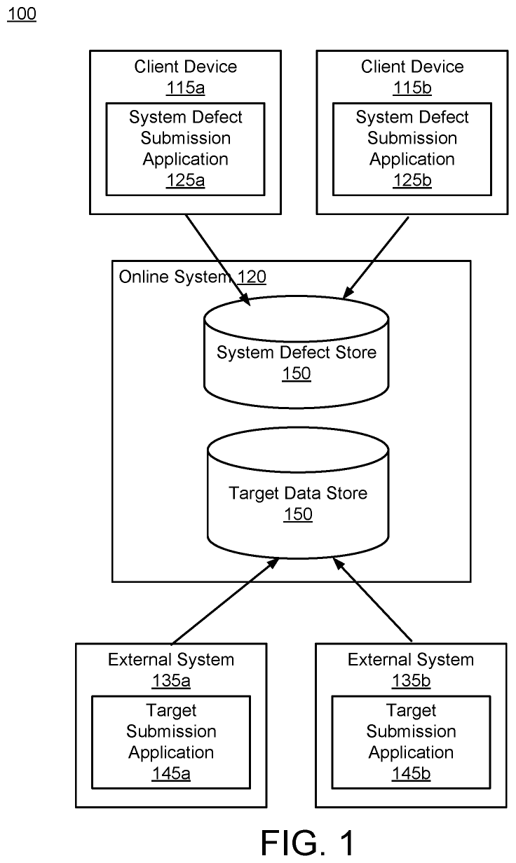

FIG. 1 is a block diagram of a system environment for identifying users for analyzing defects in a given target system, according to an embodiment. The system environment 100 includes an online system 120 that communicates with client devices 115a, 115b of users and with external systems 135a, 135b. The online system 120 may include other components not shown in FIG. 1, for example, other types of data stores, and so on. The system environment 100 may include other elements not shown in FIG. 1, for example, a network. The online system 120 may be referred to herein as a system. Certain steps of the system may be performed by the system in an offline fashion, for example, without using a network.

The online system 120 allows external systems 135a, 135b to provide information describing a target that needs to be analyzed for defects. A user of the external system may provide information describing a target using the target submission application 145a, 145b. A target being analyzed for defects is also referred to as a target system and may be an application, a website, a software service, a utility, a library, an application running on a type of device (e.g., a mobile phone), a software system, a specific feature of a system, or a hardware device. The information describing the target is stored in the target data store 155. The online system 120 allows users to access information describing the targets from the online system and analyze them and perform research to identify defects in the targets. A target may also be referred to as a target system. If a user identifies a defect in a target system, the online system allows the user to submit the identified system defect via the system defect submission application 125a, 125b. Accordingly, the online system uses crowdsourcing to identify system defects. The online system 120 stores system defects for multiple external systems in the system defect store 150. A system defect is also referred to herein as a defect or a vulnerability.

The online system 120 may send messages to users or interact with users based on their submissions of system defects. For example, the online system may compensate the users for system defects submitted by them. The online system may also communicate with users to report status of system defects reported by the users. A user providing submissions of defects is also referred to as a researcher.

An external system 135 submits information describing a target for allowing users to perform research and analysis to identify system defects. The target may be a system, a website, a software, a device, and so on. The external system 135 may specify a scope of system defect research. For example, the external system 135 may identify the scope of the research as one or more specific features of a target being analyzed. The external system 135 may identify the scope of the research as one or more targets provided by the external system. The scope of the system defect research may also be referred to as a bug bounty program since a researcher expects a reward or bounty for identifying a system defect. Each scope of system defect research specified by an external system may identify a list of targets for analysis.

The online system analyzes the targets specified within a scope of system defect research (e.g., a bug bounty program) to match the target against a set of users that are most likely to identify defects in the target. The online system may reach out to these users and inform them of the availability of the target. Reaching out to users for requesting analysis of a target consumes computing resources and human resources of the online system 120 as well as the external system for which the targets are being analyzed. For example, reaching out to a large number of users consumes computing resources and network bandwidth as well as storage resources for storing information describing the users contacted for a target. Furthermore, a user that is not well matched to a target and does not have the expertise to work on a defect may interact with the online system as well as the external systems without being able to identify a system defect, thereby consuming computing and human resources.

The online system according to various embodiments identifies users (researchers) that are well matched to a target and have high likelihood of successfully identifying defects in the target, thereby improving the efficiency of computing resources, networking resources, and storage resources of the online systems as well as external systems. In experimental setups using A/B tests, use of the techniques disclosed lead to an increase in the rate of unique valid submissions per invite of about 35%, and an increase in the payout per invite of about 77%. Furthermore, the system as disclosed improved usability since the system does not require any expert intervention and can proceed in a fully automated fashion.

The online system 120 interacts with client applications including system defect submission application 125a, 125b that execute on client devices 115a, 115b respectively or target submission applications 145a, 145b that run on external systems 135a, 135b respectively. The system defect submission application 125a, 125b presents a user interface that allows users to submit system defects to the online system 120. The submitted system defects are stored in the system defect store 150. In an embodiment, the client applications 125 and 145 are web applications that execute using a web browser. However, the client applications 125 and 145 can be other types of applications, for example, applications using proprietary communication protocols to interact with the online system 120.

The online system 120 and client devices 115 shown in FIG. 1 represent computing devices. A computing device can be a conventional computer system executing, for example, a Microsoft™ Windows™-compatible operating system (OS), Apple™ OS X, and/or a Linux OS. A computing device can also be a device such as a personal digital assistant (PDA), mobile telephone, video game system, etc.

The client devices 115 may interact with the online system 120 via a network (not shown in FIG. 1). The network uses a networking protocol such as the transmission control protocol/Internet protocol (TCP/IP), the user datagram protocol (UDP), internet control message protocol (ICMP), etc. The data exchanged over the network can be represented using technologies and/or formats including the hypertext markup language (HTML), the extensible markup language (XML), etc.

### System Architecture

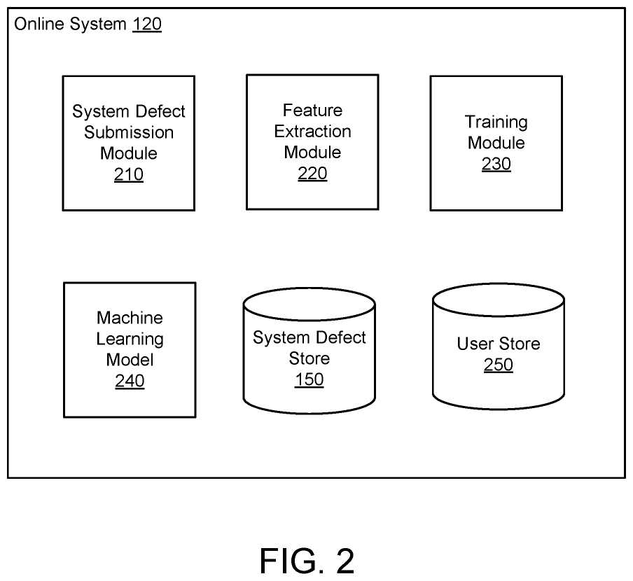

FIG. 2 is a block diagram illustrating components of an online system for matching users for identifying defects in target system by ranking users for analyzing a target system, according to one embodiment. The online system 120 comprises a system defect submission module 210, a feature extraction module 220, a training module 230, a machine learning model 240, a system defect store 150, and a user store 250. Other embodiments can have different and/or other components than the ones described here. Furthermore, the functionalities described herein can be distributed among the components in a different manner.

The system defect store 150 stores system defects submitted by users. In an embodiment, the system defect store 150 is a database, for example, a relational database or a document-based database. The system defects store 150 stores various attributes describing a system defect including information identifying an external system for which the system defect is submitted, information identifying a user that submitted the system defect, a time of submission of the system defect, and so on. In an embodiment, the system defect is specified using unstructured text, for example, natural language description of the system defect. In an embodiment, the system defect store stores a flag indicating whether a system defect is a duplicate of another system defect.

The user store 250 stores information describing the users (e.g., researchers) that contribute submissions including submissions of system defects and submissions of de-duplication rules. The user store 250 includes a unique identifier for each user. The unique identifier acts as a foreign key for the records in system defect store 150 and de-duplication rule store 245 to identify the users that provided the corresponding submission.

The system defect submission module 210 configures a user interface and presents it via the system defect submission application 125 displayed via a client device 115. The system defect submission module 210 receives system defects submitted via the user interface of the system defect submission application 125 and provided by a user. The system defect submission module 210 may store the system defect in the system defect store 150. The system defect submission module 210 may invoke the de-duplication engine 160 to determine whether the newly submitted system defect is a duplicate of an existing system defect and then stores the resulting information in the record in the system defect store 150.

The machine learning model 240 is configured to receive information describing a user and information describing a target being analyzed and predict a score for the user indicating a likelihood of the user being able to identify and submit a valid defect for the input target. The machine learning model 240 is trained by the training module 230, for example, based on historical data describing past defect submissions of different users for various targets.

The training data is labelled data where the expected output of executing the machine learning model 240 is provided. For example, if a researcher created a valid submission for this program, an output label of 1 is produced, otherwise an output label of 0 is produced. According to an embodiment, the training module 230 executes the machine learning model 240 for the training data and determines a loss value representing a difference between the predicted output values and the expected output values. The loss value may be determined using metrics such as means square error or mean absolute error. The parameters of the machine learning model 240 are modified as the training is performed to minimize the loss value. For example, the parameters of the machine learning model 240 may be modified based on a technique such as gradient descent.

### Machine Learning Model

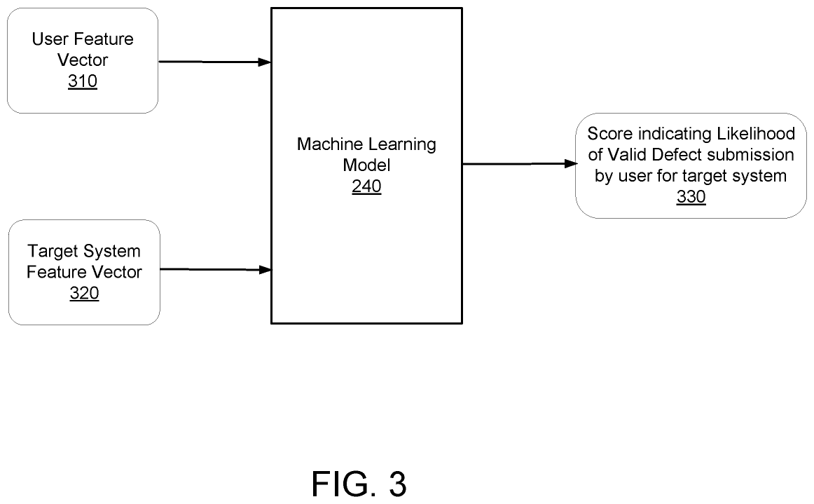

FIG. 3 shows illustrates the machine learning model used for evaluating and ranking users, according to an embodiment. The machine learning model 240 receives as inputs a feature vector 310 describing a user and a feature vector 320 describing a target system being analyzed for defects. The machine learning model 240 predicts a score 330 indicating a likelihood of the input user successfully analyzing the target system to determine and submit a defect in the target system.

The feature vector 320 describing a target is generated from various tags describing the target system. The tags describing a target system may represent various attributes describing the target system, for example, the technologies used in the target system, information describing an organization (e.g., a company) associated with the target system, a type of industry associated with the target system (e.g., an industry of a company associated with the target system), one or more types of technologies used by the target system, and so on. Tags describing a target system may be provided by experts for various target systems. Tags describing a target system may be determined by automated scanning tools. For example, features describing a target system include scraped target features obtained by scanning tools on the targets to find what ports are open and what services are likely to be running on those target systems. The system may crawl other external websites to scrape information describing the target system. A feature describing the target system may be a count of the tags available for the target system.

The feature vector 310 describing the user is generated based on tags extracted from previous valid defect submissions provided by the user. A user that performs analysis of targets for identifying system defects may also be referred to herein as a researcher. According to an embodiment, the feature vector 310 for a user comprises counts of each tag from targets system for which the user previously provided valid defect submissions. The feature vector 310 describing the user may be further based on priority levels of past defect submissions of the user, the average priority level of past defect submissions, and the counts of a vulnerability rating taxonomy associated with these submissions. The features describing the user (i.e., researcher) may include counts of various categories of prior system defects submitted by the user, counts of each priority of past submissions of the user, total number of past submissions of the user, number of accepted submissions of the user, average priority of the submissions of the user, count of the tags available for the user, and so on. The features describing the user may represent user profile attributes describing one or more of interests of the user, qualifications of the user, past experience of the user, and skills of the user.

The vulnerability rating taxonomy represents a categorization of defects and includes various categories such as server security misconfiguration, server-side injection, broken authentication and session management, sensitive data exposure, insecure OS/Firmware, broken cryptography, automotive security misconfiguration, cross-site request forgery, application-level denial-of-service, cross-site scripting, and so on. Different types of system defects or vulnerabilities that are known are classified into categories as defined by the vulnerability rating taxonomy. Other features describing the user provided as input to the machine learning model include: features reported by the user such as interests or skills. Features describing a user may include interests, skills, and experiences obtained by the system by crawling external sources linked to the researchers, such as their linkedIn, Github, HackTheBox or bug bounty service provider profiles. Features describing a user may include stakeholder ratings of researchers, for example if an expert user for example, a triager of the system described rates a given researcher as being skilled in a particular attack method. Features describing a user may include natural language processing (NLP) features, such as word embeddings derived from researcher submission texts. Features describing a target may include features of an external system associated with the target, for example the size of the company, the company's industry, and so on.

If there is no information available for the history of a user, the system finds similar users/researchers based on the data available. The system uses data from similar existing researchers to provide matches.

According to an embodiment, the user vector and the target system vectors are combined into a single vector that is provided as input to the machine learning model. Examples of tags used include, ‘.NET’, ‘API Testing’, ‘ASP’, ‘ASP.NET’, ‘AWS’, ‘AWS CodeCommit’, ‘AWS IoT’, ‘ActionScript’, ‘Adobe Experience Manager’, ‘Agriculture’, ‘Akamai CDN’, ‘Algolia’, ‘Amazon Cloudfront’, and so on.

According to an embodiment, the machine learning model is a gradient boosted decision tree. However other embodiments may use other types of machine learning models, for example, neural networks such as multi-layered perceptrons may be used.

According to an embodiment, for a target, the system creates a one hot vector storing zeros for all tags that are not present in its targets, and 1 for all tags that are present. When creating the user vector, the system may create a vector containing the counts of each tag associated with a target against which the user has made a past submission, and a zero for all other tags.

### Overall Process

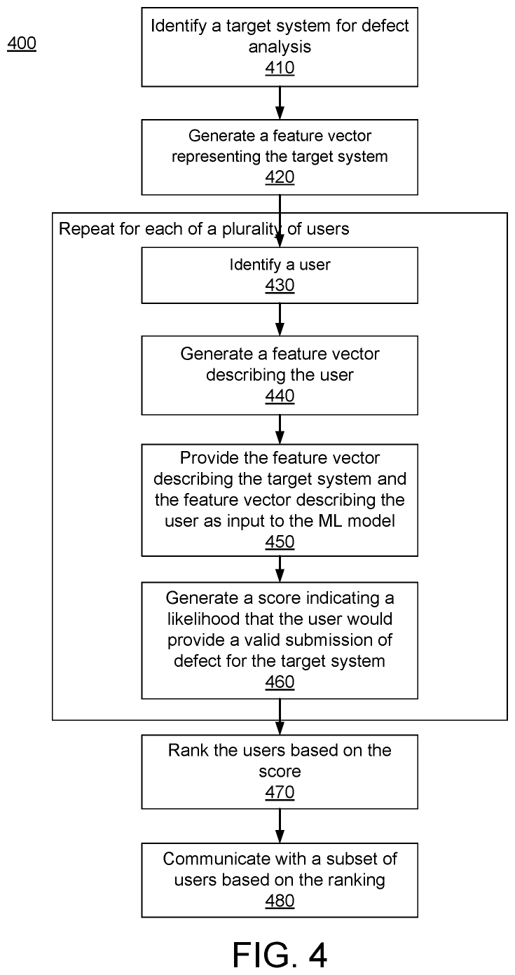

FIG. 4 is a flow chart illustrating the process 400 of determining whether a new system defect is a duplicate of another existing system defect according to an embodiment. Various embodiments can perform the steps of these flowcharts in different orders. Furthermore, various embodiments can include different and/or additional steps than the ones described herein.

The system identifies 410 a target system for performing defect analysis. For example, the target system may be specified in a scope of system defect research specified by an external system. The system generates 420 a feature vector representing the target system. The system analyzes a plurality or users to rank them using a machine learning model. The system performs the steps 430, 440, 450, and 460 for each user. The system identifies 430 a user from the plurality of users. The system generates 440 a feature vector describing the identified user. The system provides 450 the feature vector describing the target system and the feature vector describing the user as input to the machine learning model. The system executes the machine learning model to generate 460 a score indicating a likelihood that the user would provide a valid submission of a defect for the target system.

The system ranks the users based on the scores generated by the machine learning model. The system determines a subset of users based on the ranking and communicates 480 with the subset of users, for example, to request them to analyze the target system.

### Computer Architecture

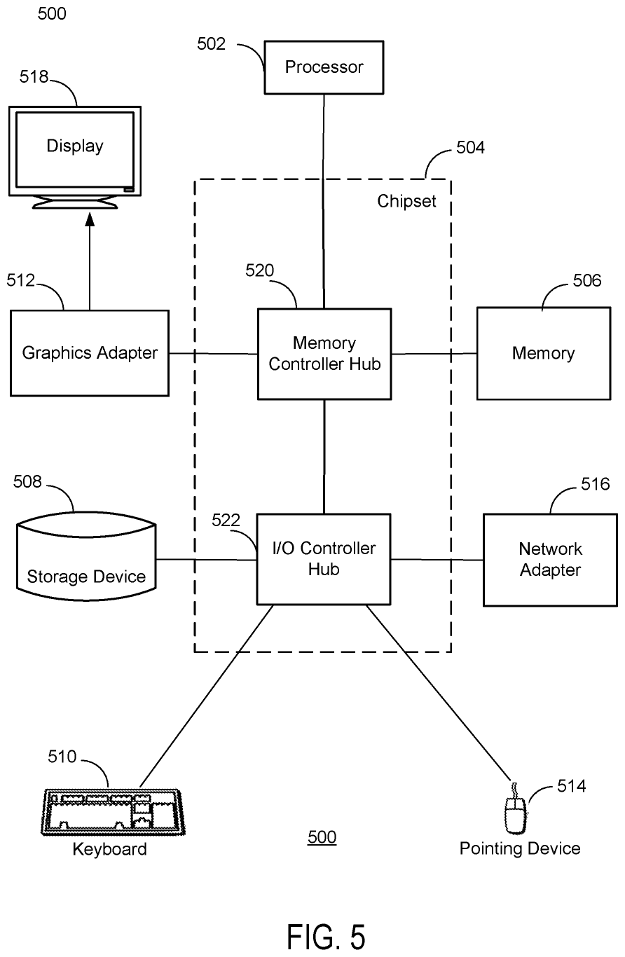

FIG. 5 is a high-level block diagram illustrating a functional view of a typical computer system for use as one of the entities illustrated in the system environment 100 of FIG. 1 according to an embodiment. Illustrated are at least one processor 502 coupled to a chipset 504. Also coupled to the chipset 504 are a memory 506, a storage device 508, a keyboard 510, a graphics adapter 512, a pointing device 514, and a network adapter 516. A display 518 is coupled to the graphics adapter 512. In one embodiment, the functionality of the chipset 504 is provided by a memory controller hub 520 and an I/O controller hub 522. In another embodiment, the memory 506 is coupled directly to the processor 502 instead of the chipset 504.

The storage device 508 is a non-transitory computer-readable storage medium, such as a hard drive, compact disk read-only memory (CD-ROM), DVD, or a solid-state memory device. The memory 506 holds instructions and data used by the processor 502. The pointing device 514 may be a mouse, track ball, or other type of pointing device, and is used in combination with the keyboard 510 to input data into the computer system 500. The graphics adapter 512 displays images and other information on the display 518. The network adapter 516 couples the computer system 500 to a network.

As is known in the art, a computer system 500 can have different and/or other components than those shown in FIG. 5. In addition, the computer system 500 can lack certain illustrated components. For example, a computer system 500 acting as a server may lack a keyboard 510 and a pointing device 514. Moreover, the storage device 508 can be local and/or remote from the computer system 500 (such as embodied within a storage area network (SAN)).

The computer system 500 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 508, loaded into the memory 506, and executed by the processor 502.

The types of computer system 500 used by the entities of FIG. 1 can vary depending upon the embodiment and the processing power used by the entity. For example, a client device 115 may be a mobile phone with limited processing power, a small display 518, and may lack a pointing device 514. An online system 120, in contrast, may comprise multiple blade servers working together to provide the functionality described herein.

### Additional Considerations

The particular naming of the components, capitalization of terms, the attributes, data structures, or any other programming or structural aspect is not mandatory or significant, and the mechanisms that implement the embodiments described may have different names, formats, or protocols. Further, the systems may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain embodiments described herein include process steps and instructions described in the form of an algorithm. It should be noted that the process steps and instructions of the embodiments could be embodied in software, firmware or hardware, and when embodied in software, could be downloaded to reside on and be operated from different platforms used by real time network operating systems.

The embodiments described also relate to apparatuses for performing the operations herein. An apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present embodiments are not described with reference to any particular programming language. It is appreciated that a variety of programming languages may be used to implement the teachings of the embodiments as described herein.

The embodiments are well suited for a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes and may not have been selected to delineate or circumscribe the inventive subject matter. Accordingly, the disclosure of the embodiments is intended to be illustrative, but not limiting.

What is claimed is:

1. A computer-implemented method for assigning target systems to users for identifying system defects, the method comprising:
receiving information describing a target system, wherein the target system is selected for analysis for identifying defects in the target system;
receiving information describing a plurality of users;
extracting features vector describing the target system;
repeating, for each user from the plurality of users:
extracting features describing the user,
providing the features describing the user and the features describing the target system as input to a machine learning model trained to receive information describing an input user and an input target system and predict a score indicating a likelihood of the input user providing a system defect in the input target system, and
executing the machine learning model to predict a score for the user;
ranking the plurality of users based on the scores predicted for the users; and
communicating with at least a subset of users selected from the plurality of users based on the ranking.

2. The computer-implemented method of claim 1, wherein the features describing the target system represent one or more of, information describing an organization associated with the target system, a type of industry associated with the target system, and one or more types of technologies used by the target system.

3. The computer-implemented method of claim 1, wherein the features describing the user represent one or more of counts of various categories of prior system defects submitted by the user, counts of each priority of past submissions of the user, total number of past submissions of the user, number of accepted submissions of the user, average priority of the submissions of the user.

4. The computer-implemented method of claim 1, wherein the features describing the user represent user profile attributes describing one or more of interests of the user, qualifications of the user, past experience of the user, and skills of the user.

5. The computer-implemented method of claim 1, wherein the features describing the user are extracted by crawling one or more websites describing user profiles.

6. The computer-implemented method of claim 1, wherein the machine learning model is a gradient boosted decision tree.

7. The computer-implemented method of claim 1, wherein the machine learning model is a neural network.

8. A non-transitory computer readable storage medium storing instructions that when executed by one or more computer processors cause the one or more computer processors to perform steps for assigning target systems to users for identifying system defects, the steps comprising:
receiving information describing a target system, wherein the target system is selected for analysis for identifying defects in the target system;
receiving information describing a plurality of users;
extracting features vector describing the target system;
repeating, for each user from the plurality of users:
extracting features describing the user,
providing the features describing the user and the features describing the target system as input to a machine learning model trained to receive information describing an input user and an input target system and predict a score indicating a likelihood of the input user providing a system defect in the input target system, and
executing the machine learning model to predict a score for the user;
ranking the plurality of users based on the scores predicted for the users; and
communicating with at least a subset of users selected from the plurality of users based on the ranking.

9. The non-transitory computer readable storage medium of claim 8, wherein the features describing the target system represent one or more of, information describing an organization associated with the target system, a type of industry associated with the target system, and one or more types of technologies used by the target system.

10. The non-transitory computer readable storage medium of claim 8, wherein the features describing the user represent one or more of counts of various categories of prior system defects submitted by the user, counts of each priority of past submissions of the user, total number of past submissions of the user, number of accepted submissions of the user, average priority of the submissions of the user.

11. The non-transitory computer readable storage medium of claim 8, wherein the features describing the user represent user profile attributes describing one or more of interests of the user, qualifications of the user, past experience of the user, and skills of the user.

12. The non-transitory computer readable storage medium of claim 8, wherein the features describing the user are extracted by crawling one or more websites describing user profiles.

13. The non-transitory computer readable storage medium of claim 8, wherein the machine learning model is a gradient boosted decision tree.

14. The non-transitory computer readable storage medium of claim 8, wherein the machine learning model is a neural network.

15. A computer system comprising:
a computer processor; and
non-transitory computer readable storage medium storing instructions that when executed by one or more computer processors cause the one or more computer processors to perform steps for assigning target systems to users for identifying system defects, the steps comprising:
receiving information describing a target system, wherein the target system is selected for analysis for identifying defects in the target system;
receiving information describing a plurality of users;
extracting features vector describing the target system;
repeating, for each user from the plurality of users:
extracting features describing the user,
providing the features describing the user and the features describing the target system as input to a machine learning model trained to receive information describing an input user and an input target system and predict a score indicating a likelihood of the input user providing a system defect in the input target system, and
executing the machine learning model to predict a score for the user;
ranking the plurality of users based on the scores predicted for the users; and
communicating with at least a subset of users selected from the plurality of users based on the ranking.

16. The computer system of claim 15, wherein the features describing the target system represent one or more of, information describing an organization associated with the target system, a type of industry associated with the target system, and one or more types of technologies used by the target system.

17. The computer system of claim 15, wherein the features describing the user represent one or more of counts of various categories of prior system defects submitted by the user, counts of each priority of past submissions of the user, total number of past submissions of the user, number of accepted submissions of the user, average priority of the submissions of the user.

18. The computer system of claim 15, wherein the features describing the user represent user profile attributes describing one or more of interests of the user, qualifications of the user, past experience of the user, and skills of the user.

19. The computer system of claim 15, wherein the features describing the user are extracted by crawling one or more websites describing user profiles.

20. The computer system of claim 15, wherein the machine learning model is a gradient boosted decision tree.
